(19) United States
(12) Patent Application Publication
(10) Pub. No.: US 2020/0130566 A1
(43) Pub. Date: Apr. 30, 2020

(54) ACTIVATING EMERGENCY LIGHTING ON TRAILERS

(71) Applicant: Frank Albritton, Pinecrest, FL (US)

(72) Inventor: Frank Albritton, Pinecrest, FL (US)

(21) Appl. No.: 16/658,546

(22) Filed: Oct. 21, 2019

Related U.S. Application Data
(60) Provisional application No. 62/751,071, filed on Oct. 26, 2018.

(51) Int. Cl. B60Q 1/30; H01R 13/703; B60Q 1/46

(52) U.S. Cl. CPC B60Q 1/305; H01R 2201/26; B60Q 1/46; H01R 13/703

(57) ABSTRACT

A trailer lighting control device enables flashing of trailer lights when the trailer is not electrically connected to a vehicle. The device uses an on-board battery which is electrically connected to the standard AUX terminal of the trailer-vehicle plug. The device has a housing which holds a socket mateable with the trailer-vehicle plug. The socket is connected to a flasher module which has a negative terminal, a positive terminal, and a load terminal. The flasher periodically electrically connects the positive terminal to the load terminal. A wiring circuit forms an electrical connection between a terminal of the socket mateable with the AUX terminal and the positive terminal of the flasher, and an electrical connection between the load terminal of the flasher and one or more terminals of the socket which are mateable with terminals of the trailer plug that are connected to lights of the trailer.

### FIELD OF THE DISCLOSURE

The disclosure relates to a system and method for activating emergency lighting on trailers, and in particular, to using an onboard power source to energize existing trailer hitch wiring to flash trailer lighting.

### BACKGROUND OF THE DISCLOSURE

Trailers towed by vehicles on public roadways are provided with lighting to indicate turns, braking, a parked state, or a hazard warning. A wiring harness on the trailer terminates with a connector which includes terminals which connect to, typically, ground/earth, left and right turn signal lights, brake lights, parking/tail lights, and reverse/backing lights. Terminals can also be provided for auxiliary power, electric braking, position lights/side markers, separate brake and tail lights, anti-lock braking power, and/or a license plate light.

Common standard configurations in North America include the 4, 5, 6, and 7-way standard connectors. A 7-way connector, for example, can conform to the SAEJ560 standard, which includes terminals for ground, position lights/side markers/clearance lights, left turn, right turn, brake lights, tail lights and license plate, and auxiliary and abs power. Connectors typically have a flat/rectangular, square, or rounded configuration.

The auxiliary power connector is used to charge a battery on board the trailer using the electrical system of the towing vehicle, and are thus connected to the on-board trailer battery. Auxiliary or Aux power is typically found on 6 and 7-way connectors, for example.

### SUMMARY OF THE DISCLOSURE

In an embodiment of the disclosure, a trailer lighting control device enabling flashing of trailer lights when a standard plug of an electrical harness of the trailer is not electrically connected to a vehicle, the trailer including an on-board battery, the plug including an AUX terminal which is a standard terminal electrically connected to the on-board battery, the device comprising a housing; a standard electrical trailer socket, of a type corresponding to the plug of the electrical harness of the trailer, positioned within the housing; a flasher module including a negative terminal, a positive terminal, and a load terminal, the load terminal periodically electrically connected to the positive terminal when voltage is applied to the negative and positive terminals; and a wiring circuit including (a) an electrical connection between a terminal of the socket mateable with the AUX terminal and the positive terminal of the flasher, and (b) an electrical connection between the load terminal of the flasher and one or more terminals of the socket which are mateable with terminals of the trailer plug that are electrically connected to lights of the trailer.

In variations thereof, the device further includes a magnet affixed to the housing, the magnet having sufficient strength to magnetically secure the housing to the trailer; the magnet is bolted to the housing; the housing further includes mounting tabs with apertures, the tabs extending from a periphery of the housing; the socket is one of a standard 6 pin connector or a standard 7 pin connector; the socket conforms to at least one of an SAE (Society of Automotive Engineers) specification and a DOT (Department of Transportation) specification; the flasher conforms to a DOT specification.

In further variations thereof, the terminals of the socket corresponding to Left Turn and Right Turn are electrically connected together; the device further includes a fuse connected to the terminal of the socket mateable with the AUX terminal; the device further includes an indicator light mounted to the housing which is electrically connected to the load terminal of the flasher; and/or the device further includes an indicator light mounted to the housing which is electrically connected to the terminal of the socket mateable with the AUX terminal.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts a perspective view of a trailer lighting control device of the disclosure;

FIG. 2 depicts the device of FIG. 1 positioned upon a trailer, alternately depicting the trailer wiring harness connected to the vehicle, and connected to the device (dashed line);

FIG. 3 is a wiring diagram of circuits within the device of FIG. 1;

FIG. 4 is a wiring diagram of an alternative circuit within the device of FIG. 1;

FIG. 5 depicts the device of FIG. 1 with a socket covering lid held open;

FIG. 6 depicts a reverse side of the device of FIG. 1, showing a magnet mounted to the device in accordance with the disclosure;

FIG. 7 is a cross-section of the device of FIG. 6, depicting mounting elements for the magnet;

FIG. 8 depicts a cover of the device of FIG. 1, separated from an enclosure, showing mounted wiring circuit elements corresponding to the wiring diagram of FIG. 4; and

FIG. 9 is a side view of the cover of FIG. 8.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

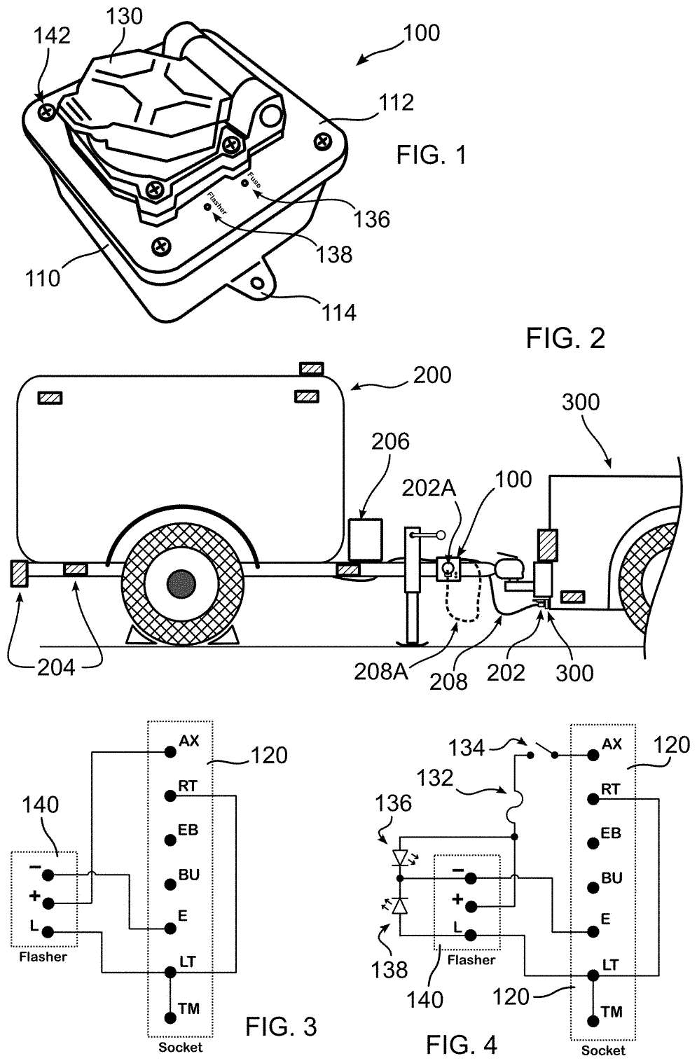

Referring now to FIGS. 1-2, a trailer lighting control device 100 of the disclosure enables flashing of trailer lighting when the trailer is disconnected from a vehicle 300. Device 100 uses a battery 206 of the trailer to energize lights 204 of trailer 200, whereby a connector 202 of trailer 200 can be plugged into device 100 in the same manner as connector 202 is plugged into socket 302 of a vehicle, and lights of the trailer will begin flashing. In an embodiment, lights of the trailer will flash in this manner as they would if the ‘hazard’ switch was pressed within the vehicle with the trailer electrically connected to the vehicle. In FIG. 2, connector 202, attached to a trailer wiring harness 208 is shown plugged into socket 302 of the vehicle, and as alternatively represented by a dashed cable 208A, connector 202 can be plugged into device 100 (shown as connector 202A).

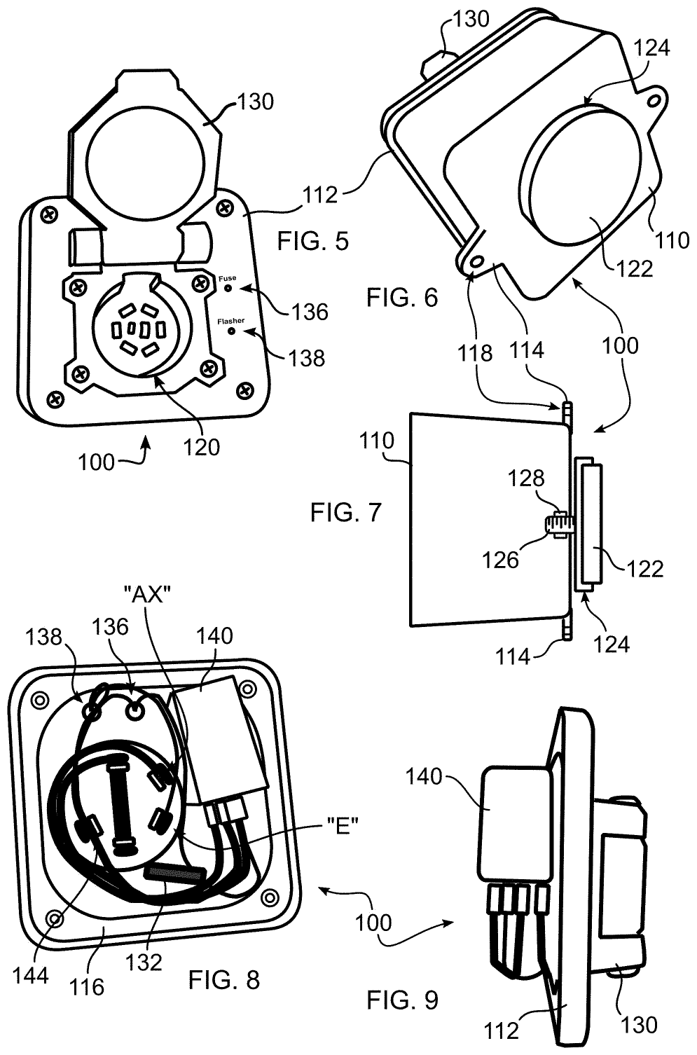

With additional reference to FIGS. 5-9, device 100 includes a housing 110 having a cover 112, which can attach to housing 110 to form a watertight interior within housing 110. Such attachment can include a gasket 116 which can be precut or formed from a liquid, and can further include or comprise clips, snaps, or screws 142 to align and maintain cover 112 upon housing 110. Housing 110 and cover 112 can be fabricated from any material of sufficient strength and durability for the uses described herein, and which advantageously does not corrode or degrade when placed outside in sunlight, rain, or a marine environment for an extended period. Examples include a natural material such as rubber, a synthesized material such as plastic, including ABS or PVC, or a metal or alloy such as steel or aluminum, any of which may be treated, coated, or painted for additional durability or improvement in appearance.

One or more mounting tabs 114, which can have apertures 118 for screws or fasteners, can be used to secure device 100 upon a surface of a trailer 200. Tabs 114 can be integrally molded as part of housing 112 during production of housing 112, or they can be attached to housing 112 using any known means, including for example welding, brazing, gluing, and bolting. Tabs 114 can be reversibly attached to housing 112 using a fastener, such as a clip or screw. In an embodiment, tabs 114 can be moved to a position which does not extend beyond a periphery of housing 110 when not in use.

In an embodiment shown in FIGS. 6-7, a magnet 122 is mounted to a surface of housing 110. Magnet 122 can be attached using an adhesive, clips, snaps, bands, press-fit or any other method, directly to housing 110. Alternatively, magnet can likewise be fastened within a mounting bracket 124, as shown in FIG. 7, the mounting bracket in turn secured to housing 114 using any known means, including for example a bolt 126 and nut 128. Magnet 122 can further be directly bolted to housing 110. Magnet 122 can be a permanent magnet, which can include neodymium or other rare earth type, electromagnet, ferrite magnet, magnetically active alloy, or any other type of magnet.

Magnet 122 thus facilitates deployment of device 100 with any trailer, as it is readily mountable at a convenient location upon a ferrous or magnetically active component of the trailer, for example the frame, tire mount, or winch. Device 100 can therefore be stowed in a vehicle or other storage location for use as needed, regardless of which trailer requires emergency lighting while disconnected from a vehicle. As such, device 100 does not need to be stowed with or attached to each trailer, although this is nonetheless an option.

A socket 120 is mounted upon either housing 110 or cover 112. In the figures herein, socket 120 is mounted upon cover 112, facilitating mounting and servicing of parts which are disposed within housing 110 when cover 112 is mounted upon housing 110, and which are exposed as shown in FIGS. 6-7 when cover 112 is dismounted. However, socket 120 can be mounted upon any surface of housing 110 instead of upon cover 112. Socket 120 corresponds to a compatible type of socket mounted upon a vehicle which is operationally mechanically and electrically connectable to the trailer. Socket 120 can be purchased off-the-shelf as a standard part, intended for installation in a vehicle. As such, it can be provided with a spring loaded gasketed socket cover or lid 130.

As further explained herein, socket 120 includes an auxiliary electrical terminal which is oriented to connected to a corresponding auxiliary electrical terminal of wiring harness 202 of trailer 200. In FIG. 5, socket 120 can be seen to include 7 contact terminals corresponding to the terminals diagrammed in FIGS. 3-4. For the embodiment shown, the order in which the terminals are arranged corresponds to FIGS. 3-4, although the central terminal corresponds to reverse lights. It should be understood, however, that any standard socket can be used, provided, however, that at least one terminal is designated by the applicable standard for connection to a battery located on the trailer, and at least one terminal is designated by the standard for connecting to lighting 204 of the trailer. Another example includes a standard rectangular 6 way connector. Socket 120 can be of a type which conforms to a DOT (U.S. Department of Transportation or other governmental transportation regulating agency) specification, or an SAE (Society of Automotive Engineers or other recognized standards association) specification.

Other standardized trailer connectors for North America can be found at https://en.wikipedia.org/wiki/Trailer_connectors_in_North_America; for Europe at https://en.wikipedia.org/wiki/Trailer_connectors_in_Europe; and which are ISO compliant at https://en.wikipedia.org/wiki/ISO_standards_for_trailer_connectors. In accordance with the disclosure, both the connector 202 at the end of the trailer wiring harness 208 and the connector 300 of the vehicle are mating standardized connectors, available from a variety of retail and commercial sources, whereby no retrofitting or altering of the vehicle or the trailer is required in order to use device 100 or to carry out the disclosure.

As shown in FIGS. 3-4, which reflects a standardized 7 pin connector, the terminals are indicated as follows: AX=Auxiliary Power, RT=Right Turn, EB=Electric Brake, BU=Backup Lights, E=Earth/Ground, LT=Left Turn, and TM=Tail Lights/Markers/License Plate. In the configuration shown, AX is connected to a battery located on the trailer as is generally the case with this terminal, whereby the connector is conventionally to supply recharging power for battery 206 from the towing vehicle. In accordance with the disclosure, however, the AX terminal is alternatively used to supply power to a flasher 140 and to energize trailer lighting under control of the flasher, and in an embodiment, to power indicator lights, all as diagrammed in FIGS. 3-4.

More particularly, power from the battery is conventionally routed to the AX terminal of a standard trailer connector 202. This power is routed through a standard mating socket 120 which has been provided with internal wiring as shown in FIGS. 3-4 and as shown in FIGS. 8-9. A wire is connected to the AX terminal and power is routed to the positive (“+”) input for flasher 140. The ground from connector 202 is connected to terminal E and from there by a wire to the negative (“−”) input for flasher 140, thereby energizing flasher 140, which as normal begins to alternate supplying and terminating power to an output or Load terminal (“L”) in accordance with a predetermined or set frequency. Power routed through the Load terminal is also derived from the AX terminal, but is routed within flasher 140. Output from the Load terminal is connected to whichever trailer lighting it is desired to flash. In the example of FIGS. 3-4, this includes the left and right turn signals, and the tail markers and any other lights electrically connected to the tail markers (LT, RT, TM).

As the disclosure uses a standard socket 120 with screw mounted terminals 144, it is possible to easily change the particular combination of lights which will be illuminated by flasher 140 by electrically connecting terminals corresponding to each of such lights to the load terminal of flasher 140. While the embodiment of socket 120 illustrated includes screw terminals 144 which are very easy to reconfigure, other types of terminal connectors are available for socket 120, such as push on stakes or other releasable connections, which can be reconfigured in a similar manner, although it may be necessary to re-crimp or solder leads to connectors as desired.

It should be understood that an advantage of the disclosure is that a selection of lights to flash can be determined simply by the electrical connections formed between the Load terminal and any connector of socket 120, thereby enabling great flexibility. If cover 112 is openable by an end user, it is possible for an end user to change the terminals which would be energized by the Load terminal. As shown in FIGS. 8-9, the standard socket 120 selected includes screw terminals which secure the wires described and shown herein to desired terminal locations, thus facilitating reconfiguration at the point of manufacture, or by the end user.

If desired, diodes (not shown) can be used, as understood within the art, to isolate left side and right side markers, for example to avoid wiring incompatibility with German or other vehicles which enable independent control of certain left and right side lighting, such as parking lights.

Thus, in accordance with the disclosure, when connector 202 is inserted into socket 120, and assuming battery 206 is sufficiently charged, lights connected to the Load terminal begin to flash at a rate determined by flasher 140. In accordance with an embodiment of the disclosure, flasher 140 is an off-the-shelf product specifically designed for use in roadway vehicles, and thus flashes at a legally prescribed rate.

FIG. 4 illustrates additional optional elements any one or all of which can be included within device 100, including an overcurrent fuse 132, a main on/off switch 134 (shown in FIG. 4 only), a power indicator light 136, and a flash indicator light 138. Fuse 132 is connected in series in the power circuit through AX, and can be a single use fuse, or a resettable type fuse, and can provide ground fault interruption protection. Main on/off switch 134 interrupts power from terminal AX to flasher 140, and can be provided upon cover 112 or housing 110, avoiding a need to disconnect connector 202 to interrupt flashing. Indicator lights 136 and 138 can be provided in the form of LED lights mounted in cover 112, as shown in FIG. 5, or can be positioned anywhere upon device 100, or can be remotely connected to device 100. Indicia in English or other language can be provided to indicate the meaning of lights 136 and 138, and to indicate the meaning, purpose or function of other parts of device 100.

The components of the systems and apparatuses may be integrated or separated. Moreover. The systems and apparatuses disclosed herein may be performed by more, fewer, or other components, and methods may include more, fewer, or other steps. Applicants do not intend any of the claims to invoke 35 U.S.C. 112(f) unless the words “means for” or “step for” are explicitly used in the particular claim.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A trailer lighting control device for enabling flashing of trailer lights when a standard plug of an electrical harness of the trailer is not electrically connected to a vehicle, the trailer including an on-board battery, the plug including an AUX terminal which is a standard terminal electrically connected to the on-board battery, the device comprising:
a housing;
a standard electrical trailer socket, of a type corresponding to the plug of the electrical harness of the trailer, positioned within the housing;
a flasher module including a negative terminal, a positive terminal, and a load terminal, the load terminal periodically electrically connected to the positive terminal when voltage is applied to the negative and positive terminals; and
a wiring circuit including
(a) an electrical connection between a terminal of the socket mateable with the AUX terminal and the positive terminal of the flasher, and
(b) an electrical connection between the load terminal of the flasher and one or more terminals of the socket which are mateable with terminals of the trailer plug that are electrically connected to lights of the trailer.

2. The device of claim 1, further including a magnet affixed to the housing, the magnet having sufficient strength to magnetically secure the housing to the trailer.

3. The device of claim 2, wherein the magnet is bolted to the housing.

4. The device of claim 1, wherein the housing further includes mounting tabs with apertures, the tabs extending from a periphery of the housing.

5. The device of claim 1, wherein the socket is one of a standard 6 pin connector or a standard 7 pin connector.

6. The device of claim 1, wherein the socket conforms to at least one of an SAE (Society of Automotive Engineers) specification and a DOT (Department of Transportation) specification.

7. The device of claim 1, wherein the flasher conforms to a DOT specification.

8. The device of claim 1, wherein terminals of the socket corresponding to Left Turn and Right Turn are electrically connected together.

9. The device of claim 1, further including a fuse connected to the terminal of the socket mateable with the AUX terminal.

10. The device of claim 1, further including an indicator light mounted to the housing which is electrically connected to the load terminal of the flasher.

11. The device of claim 1, further including an indicator light mounted to the housing which is electrically connected to the terminal of the socket mateable with the AUX terminal.
